(19) United States
(12) Patent Application Publication
(10) Pub. No.: US 2005/0086515 A1
(43) Pub. Date: Apr. 21, 2005

(54) Motion detecting computer control device

(76) Inventor: Clifford D. Paris, Manassas, VA (US)

Correspondence Address: WELSH & FLAXMAN LLC, 2450 CRYSTAL DRIVE, SUITE 112, ARLINGTON, VA, 22202, US

(21) Appl. No.: 10/964,622

(22) Filed: Oct. 15, 2004

Related U.S. Application Data
(60) Provisional application No. 60/551,042, filed on Mar. 9, 2004.
(60) Provisional application No. 60/511,631, filed on Oct. 15, 2003.

(51) Int. Cl. G06F 11/30

(52) U.S. Cl. 713/200

(57) ABSTRACT

The present invention is directed to a security based computer system providing protection from unauthorized viewing of a computer monitor, including a central processing unit coupled to a monitor and a keyboard, a motion detector providing a signal as an individual approaches the vicinity of the monitor and a system for receiving the signal generated by the detector and instructing the monitor to alter a current screen shown on the monitor to protect the current screen from being viewed by the individual.

### CROSS REFERENCE TO RELATED APPLICATION

This application is based upon U.S. Provisional Patent Application Ser. Nos. 60/551,042, entitled “Motion Detecting Computer Control Device”, filed Mar. 9, 2004, which is currently pending and 60/511,631, entitled “Motion Detecting Computer Control Device”, filed Oct. 15, 2003, which is currently pending.

### BACKGROUND OF THE INVENTION

1. Field of the Invention

The invention relates to a motion detecting device for use in conjunction with a computer. More particularly, the invention relates a computer system including a motion detecting device that operates to automatically alter the presence of a computer monitor when an individual is detected in the vicinity of the monitor.

2. Description of the Prior Art

Computers have become an integral part of the workplace. In fact, almost every desk within an office will have a computer thereon. These computers are utilized for research, document production, communication and a wide variety of other business related activities. As such, individuals often have different subject matter placed upon their monitors for ready viewing.

In conjunction with the widespread use of computers within the workplace, many offices have adopted a modular work environment, wherein workspaces are divided into cubicles in which individuals work. These cubicles oftentimes do not have doors. As such, individuals passing by a specific cubicle will have ready access to materials and articles kept within the cubicle. In addition, cubicle walls are generally six feet tall or less. As such, it is possible for people to look over a cubicle wall and view the activities taking place within the cubicle.

With this in mind, and in consideration of the propensity for individuals to utilize their computer monitors for various purposes, including, but not limited to document production and communications, someone passing by a cubicle will have the opportunity to view the material being displayed upon the monitor.

This is not always desirable as many projects are either confidential or have secure information contained therein. One way in which the contents of a computer monitor are protected is through the utilization of screen saver programs. Such programs, which were originally developed to prevent “burnin” on cathode ray tubes, have evolved into security mechanisms which prevent unauthorized use of a computer. That is, screen saver programs have been developed with passwords, requiring that passwords be input before access is provided to the computer once the screen saver program has gone into affect. However, screen saver programs are commonly operated under a timing system, wherein the screen saver program is initiated after the program notices a lack of activity of the computer for a specified period of time. As such, screen saver programs are not effective as protection from individuals viewing computer monitors while another individual is working on the computer.

In addition to screen savers, proximity detectors have been developed. These detectors function by warning a computer user as an individual comes into the vicinity of the computer. As such, these devices require action by the computer user if he or she wishes to protect the contents shown on the monitor from an individual in the vicinity.

A need, therefore, exists for a system that will protect individual users from inadvertent and undesirable screen viewing by individuals passing by a cubicle or office space where the computer monitor is visible to passer buyers. The present invention provides such a security system. In fact, the present system allows an individual who is researching a surprise, viewing something medical, personal or otherwise private or performing secure work to hide it from other individuals in a convenient and reliable manner.

### SUMMARY OF THE INVENTION

It is, therefore, an object of the present invention to provide a security based computer system including software providing protection from unauthorized viewing of a computer monitor, including a central processing unit coupled to a monitor and a keyboard, a motion detector providing a signal as an individual approaches the vicinity of the monitor and means for receiving the signal generated by the detector and instructing the monitor to alter a current screen shown on the monitor to protect the current screen from being viewed by the individual.

It is a further object of the present invention to provide a computer system wherein the means for receiving is associated with the central processing unit and the central processing unit directly alters the current screen shown on the monitor.

Another object of the present invention to provide a computer system wherein the current screen is caused to go blank upon the identification of an individual in the vicinity or where the current screen is caused to switch to an alternate security screen upon the identification of an individual in the vicinity.

Still another object of the present invention is to provide means for reverting back to the screen before switching occurred, such as an icon that may be clicked on to revert or a predetermined keystroke.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the present motion detecting computer system.

FIG. 2 is a flow chart diagramming operation of the present system.

FIGS. 3, 4, 5, 6, 7a and 7b disclose various mechanisms for altering the screen of the monitor.

FIGS. 8, 9, 10 and 11 are exemplary views of the menu for utilization in accordance with the present system.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

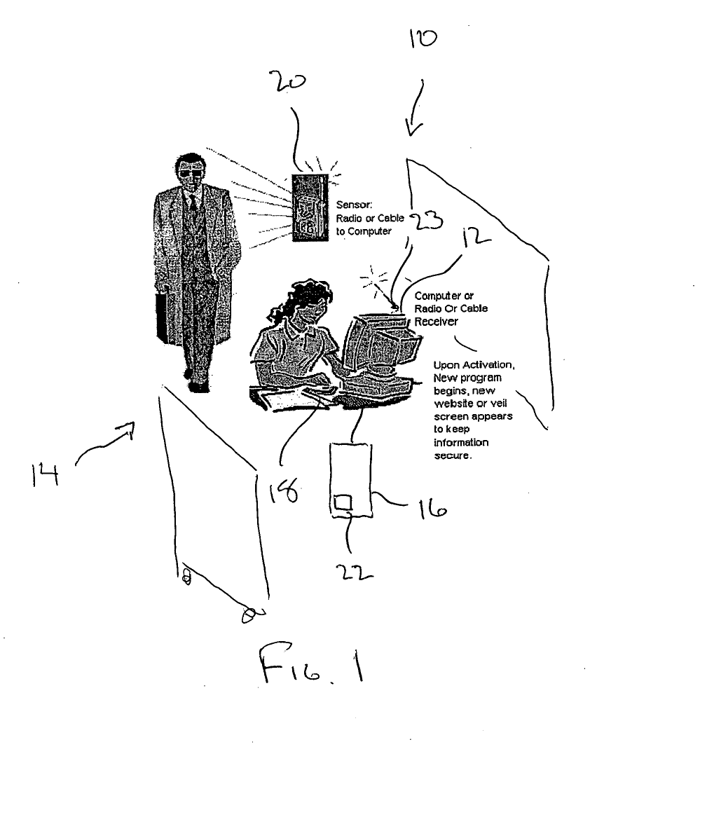

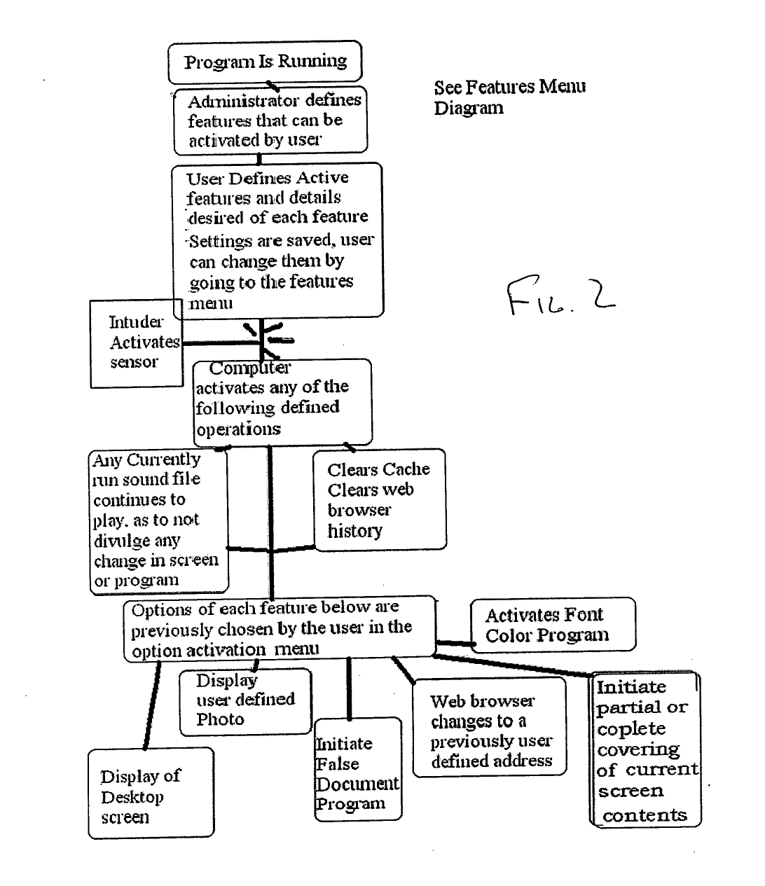

With reference to FIG. 1, a security based computer system 10 is disclosed. The computer based security system 10 provides protection from unauthorized viewing of a computer monitor 12. As shown in FIG. 1, the security based computer system 10 is adapted for use in conjunction with cubicles 14 and other office spaces in which an individual passing by the computer monitor 12 will have ready access to the contents displayed upon the computer monitor 12. However, those skilled in the art will appreciate that the present security based computer system 10 may be employed in a variety of environments without departing from the spirit of the present invention.

Briefly, the security based computer system 10 includes a central processing unit 16 coupled to a monitor 12 and a user input device 18. These components may be conventional and will be programmed to function in conjunction with the security system defined below.

In particular, the security portion of the present system 10 is provided by positioning a detector 20 along the perimeter of the cubicle or office space 14. In accordance with a preferred embodiment of the present invention, the detector 20 is a motion detector observing and signaling when individuals pass within the vicinity of the central processing unit 16, monitor 12 and/or user input device 18. With this in mind, the system 10 is provided with a mechanism for adjusting the sensitivity of the motion detector 20 to ensure that the system 10 is only actuated when truly necessary. As those skilled in the art will appreciate, actuation of the system describes the present system's ability to hide contents of a monitor screen upon the detection of a nearby person and the system itself is always operating to detect individuals and actuate the system for hiding the content.

The detector 20 may be provided with a clamp, or adhesive or any other means for attachment to a cubicle wall. In addition, the detector 20 may be provided with a case for insertion into ordinary objects, such as, desk items or stuffed animals, or behind photos, clocks or wall hangings.

In conjunction with the motion detector 20, a receiving mechanism 22 for receiving the signal generated by the detector 20 and instructing the monitor 12 to alter a current screen shown on the monitor 12 is associated with the security based computer system 10. In accordance with a preferred embodiment of the present invention, the motion detector 20 sends signals via a wireless protocol to a receiver element 23 which forwards the signal to the receiving mechanism 22. However, those skilled in the art will certainly appreciate that other transmission mechanisms, such as, hard wiring, may be employed without departing from the spirit of the present invention.

In practice, the motion detector 20 identifies the presence of an approaching individual within the vicinity of the monitor 12 and/or user input device 18 and issues a signal. The signal is identified by the receiving mechanism 22 and instructions are generated for altering the current screen shown on the monitor 12 to protect the current screen from being viewed by the approaching individual.

The term “alter” is meant to refer to a variety of changes which might be employed to hide the current screen shown on the monitor 12. For example, it is contemplated that the current screen may be blanked out and a black screen shown upon the computer monitor 12. If this is not desired, the current screen may be simply replaced with a predetermined nonsecure screen or the current screen may be replaced with a screen saver. It is also contemplated the system may employ various screen filters that will allow the user to continue working while preventing nearby individuals from view the contents of the screen. Such a system would be especially useful in closed spaces, for example, an aircraft while a laptop is being used.

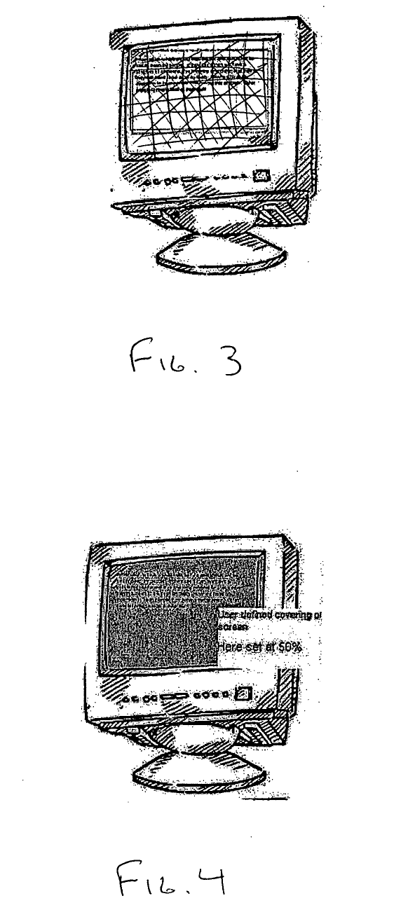

In accordance with a preferred embodiment of the present invention, and with reference to FIG. 3, the monitor 12 is altered by dimming (or adjusting the transparency of the screen). The amount of dimming is adjustable from slight to completely black. Adjustment is made via an administrative menu provided in conjunction with the present system and discussed below in greater detail. For example, dimming may be achieved through the use of a veil (or coating) composed of a mesh like coating which is part of the monitor or an addition thereto, adjustable from off white to grayish, to black and anywhere in between. The veil may be adjustable in color and density and as the user chooses to make the veil darker, the veil will function to cover more and more of the screen of the monitor 12. This veil will react quickly to actuation of the present system, yet the appearance of the veil can be pleasing to the eye for example, appearing as a wave, dissolving the work slightly or greatly. The veil should not appear in a startling manner, but should be soft, soothing and quick. The color of the transparent fill may further be adjusted as shown with reference to the user menu discussed below in greater detail.

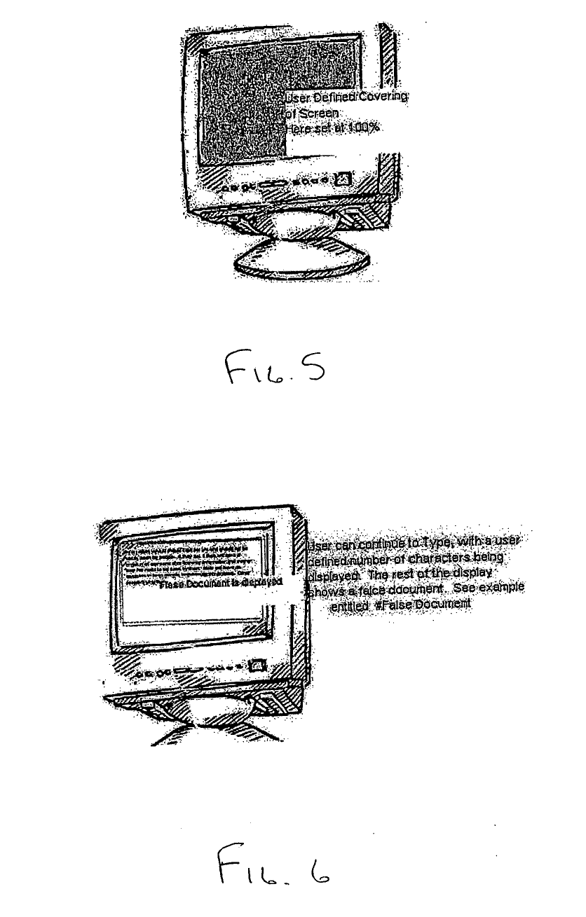

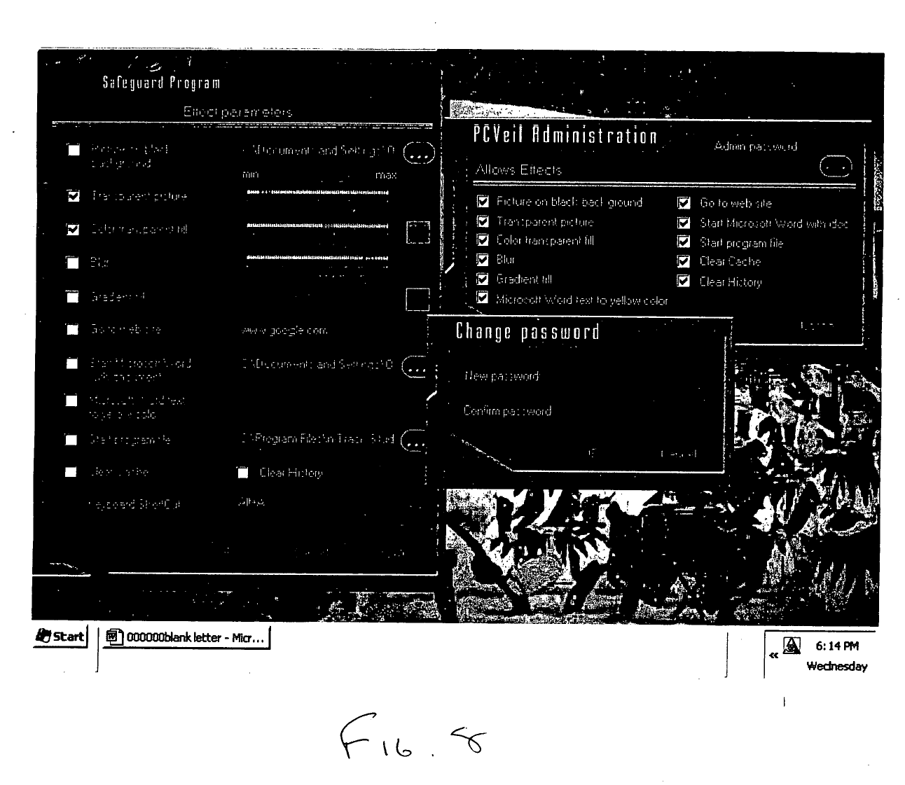

It is further contemplated the current screen of the monitor 12 may be altered by covering a specific portion of the screen through the implementation of a cover screen program as shown in FIGS. 4 and 5, and discussed below with regard to the operating menu. This program provides for the automatic coverage of a specified portion of the monitor 12 upon actuation of the present system, leaving an uncovered, open block in which the user may continue working. The program allows the user to designate coverage ranging from 1% to 100% (see FIGS. 4 and 5). This feature may be further enhanced by moving the open block as the cursor moves about the screen (see FIGS. 7a and 7b).

Other contemplated alterations include converting the current screen of the monitor to a predefined photo or web page upon actuation of the system. The color or font of the current screen (for example, converting text in Microsoft Word to yellow) may also be altered to make viewing difficult for one passing by the monitor allowing the user to still work on the computer while it is not viewable by passers by.

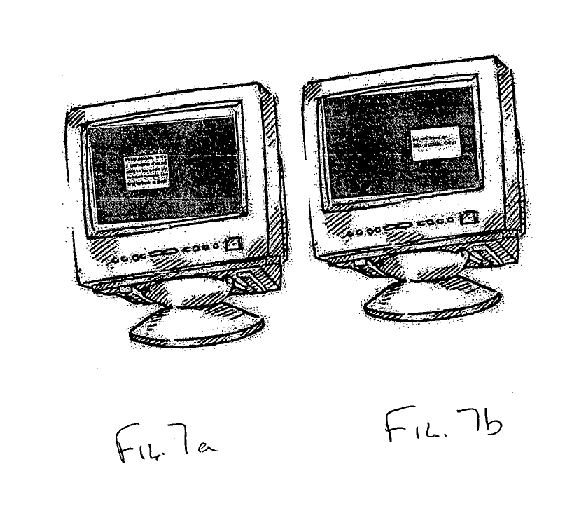

It is also contemplated the screen may be altered to only show a predefined number of letters or characters upon the actuation of the present system; that is, a false document program (see FIG. 6). The false document program alters all characters with the exception of a predefined number of characters immediately adjacent to the portion of the document upon which the user is working. For example, a user might specify that 10 characters are to be shown in the false document program and all but the ten characters adjacent the cursor position will be altered upon actuation of the present system. As a result, the user will be permitted to continue working while the remainder of the document is hidden from an individual passing by the monitor.

It is further contemplated the screen may be altered by imposing a predefined “blur” upon the screen to deter nearby people from readily viewing the contents of the screen. More particularly, the screen is blurred to a predetermined extent. The extent of blur will allow the computer user to readily view the contents of the screen while preventing those standing a distance from the screen from viewing the contents of the screen.

It is conceivable the receiving mechanism 22 for generating instructions to alter the monitor 12 may be incorporated within various components of the security based computer system 10. However, and in accordance with a preferred embodiment of the present invention, the receiving mechanism 22 is associated with the central processing unit 16 and the central processing unit 16 directly alters the current screen shown on the monitor 12 upon receiving a signal from the motion detector 20.

It is, however, contemplated the mechanism for receiving the signal may be associated with the detector and the detector therefore sends the signal for altering the current screen shown on the monitor 12. Further, and in accordance with yet another embodiment, the receiving mechanism may be associated with the user input device and the user input device instructs the monitor to alter the current screen shown on the monitor after receiving a signal from the motion detector. In addition, the receiving mechanism may be associated directly with the monitor and the motion detector sends a signal directly to the monitor for altering the current screen shown on the monitor. As those skilled in the art will certainly appreciate, other configurations may be possible without departing from the spirit of the present invention.

Regardless of the specific connection arrangement employed, it is contemplated that components making up the present system may be connected using Serial or USB connections. However, those skilled in the art will appreciate a variety of connection techniques which may be employed in accordance with the present invention.

The system is provided with a return function. In accordance with a preferred embodiment, the user merely strikes a key or clicks upon a specific icon to restore the screen to its original configuration. The specific key or icon may be chosen through utilization of the system menu. The icon may also be hidden on the screen such that only the user of the monitor knows where to click.

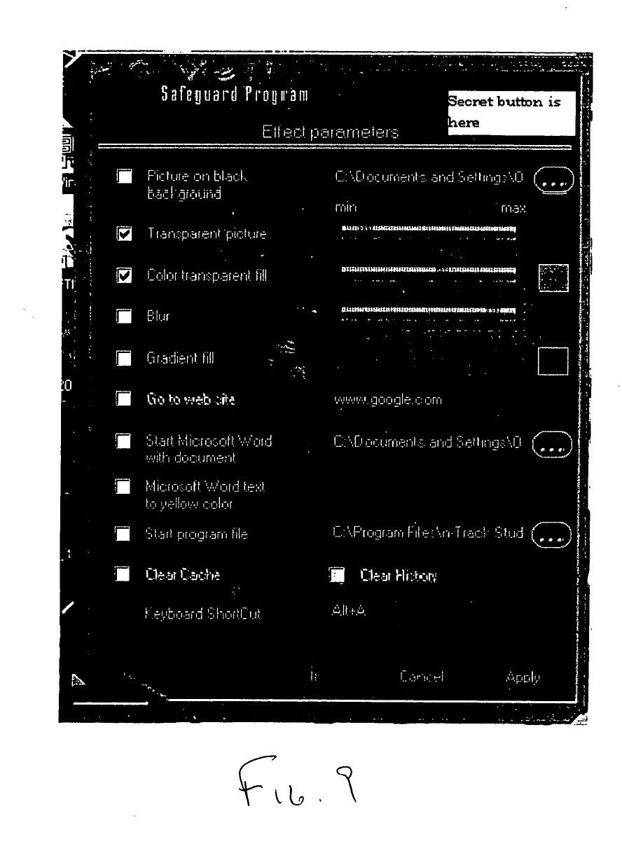

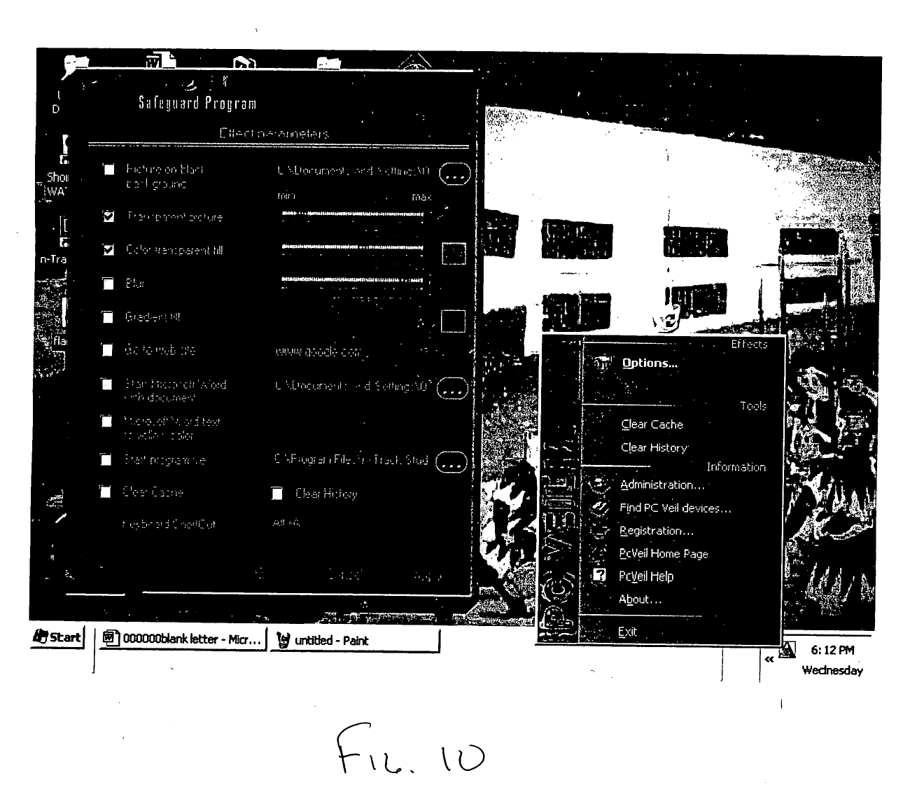

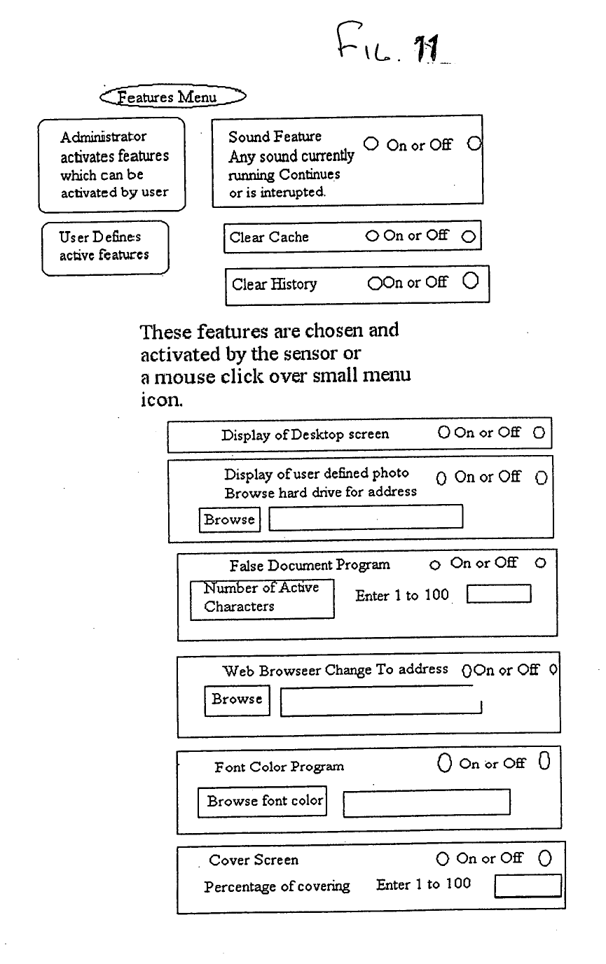

In accordance with a preferred embodiment of the present invention, and with reference to FIGS. 8, 9 10 and 11, a menu (or user interface) is provided which is adapted for providing a user with control over the specific operating parameters of the present system. As those skilled in the art will certainly appreciate, the menu disclosed in accordance with a preferred embodiment of the present invention may be varied without departing from the spirit of the present invention.

The menu includes mechanisms for turning sound alarms on and off. The menu also provides for the total muting of the computer, so that the while user is switching programs, changing web sites, etc, the computer will not give audible indications of activity. The menu also provides for clearing cache and clearing history in the event the system is actuated. This feature includes additional functionality providing that upon the actuation of the clear history or clear cache feature, the history of the sites visited is recorded into a password protected list. The list is accessible to the user and allows the user to return to the website where they were before the unit was actuated into a protection mode.

As shown in the various figures, the menu also permits the user to adjust the “transparent picture” status (that is, the extent of dimming as discussed above), the “color transparent fill” status, the extent of “blur”, the gradient fill, the website to which the system switches, the switching of Microsoft Word documents to yellow, as well as other program files which may be started in accordance with the dictates of the present system. The menu also provides the user with the option of manually activating the present system through the activation of a keyboard shortcut. As those skilled in the art will appreciate, all of the alteration functions discussed above are not shown in the present menu as this is merely a preferred embodiment of a menu and those skilled in the art would understand how to incorporate additional alteration functions into the menu.

If the occupant chooses to allow the intruder access to the computer, there is no ability for the intruder to see the occupant's past activities; such as, in a shared or competitive work environment. The cache clear and history clear are administratively controlled. Therefore, if it is used in a work environment or installed by parents in a home environment it cannot be misused. Keeping material private is the key. Anyone working on any matter requiring confidentiality is obligated to never allow certain information to be divulged. Clearing the Internet cache eliminates history of any research, so the computer user cannot find this information.

The menu further provides for designating whether the desktop should be displayed upon actuation of the present system. The menu also allows the user to choose whether to display a specific photo upon actuation, whether to employ the false document program upon actuation, whether to activate a web browser address change upon actuation, whether to employ font/color change upon actuation or whether to employ a cover screen upon actuation.

To provide added functionality, and as shown above, the system menu will allow the user to browse the hard drive or network to choose specific programs to run when the sensor is activated. As such, a secure screen may be automatically converted to family photos upon the identification of an individual in the proximity of the present system. Similarly, a specific website may be activated upon identification of an individual in the proximity.

It is further contemplated the system may be enhanced with a personal identification system, such as a multi-level security card system. A security card reader, sensitive to the room, will identify the level of a new person entering the space. Using previously qualifying levels, this person will be allowed or not allowed to view the monitor, therefore the monitor is available or not, and/or activation of the predefined functions will or will not occur. As those skilled in the art will also certainly appreciate, the present system may be turned off such that the contents of the screen are not protected as individuals pass by.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A security based computer system providing protection from unauthorized viewing of a computer monitor, comprising:
a central processing unit coupled to a monitor and a user input device;
a detector providing a signal as an individual approaches the vicinity of the monitor;
means for receiving the signal generated by the detector and instructing the monitor to alter a current screen shown on the monitor to protect the current screen from being viewed by the individual.

2. The computer system according to claim 1, wherein the means for receiving is associated with the central processing unit and the central processing unit directly alters the current screen shown on the monitor.

3. The computer system according to claim 1, wherein the current screen is caused to go blank upon the identification of an individual in the vicinity.

4. The computer system according to claim 1, wherein the current screen is caused to switch to an alternate security screen upon the identification of an individual in the vicinity.

5. The computer system according to claim 1, wherein the detector is a motion detector.

6. The computer system according to claim 5, wherein the current screen is caused to switch to an alternate security screen upon the identification of an individual in the vicinity.

7. The computer system according to claim 1, wherein the current screen is caused to blur upon the identification of an individual in the vicinity.

8. The computer system according to claim 1, further including means for reverting to the current screen.

9. The computer system according to claim 8, wherein the reverting means includes an icon that may be clicked on to revert.

10. The computer system according to claim 8, wherein the reverting means includes a predetermined keystroke.

11. A security system adapted for associated with a computer system including a central processing unit, a monitor and a user input device, the security system providing protection from unauthorized viewing of a current screen shown on a computer monitor, the security system comprising:
a detector providing a signal as an individual approaches the vicinity of the monitor;
means for receiving the signal generated by the detector and instructing the monitor to alter a current screen shown on the monitor to protect the current screen from being viewed by the individual.

12. The security system according to claim 11, wherein the means for receiving is associated with the central processing unit and the central processing unit directly alters the current screen shown on the monitor.

13. The security system according to claim 11, wherein the current screen is caused to go blank upon the identification of an individual in the vicinity.

14. The security system according to claim 11, wherein the current screen is caused to switch to an alternate security screen upon the identification of an individual in the vicinity.

15. The security system according to claim 11, wherein the detector is a motion detector.

16. The security system according to claim 15, wherein the current screen is caused to switch to an alternate security screen upon the identification of an individual in the vicinity.

17. The security system according to claim 15, further including means for reverting to the current screen.

18. The security system according to claim 17, wherein the reverting means includes an icon that may be clicked on to revert.

19. The security system according to claim 17, wherein the reverting means includes a keystroke.

20. The security system according to claim 11, wherein the current screen is caused to blur upon the identification of an individual in the vicinity.
